(19) United States
(12) Patent Application Publication
(10) Pub. No.: US 2012/0110083 A1
(43) Pub. Date: May 3, 2012

(54) Inter-Corporate Collaboration Overlay Solution for Professional Social Networks

(75) Inventors: David Burritt, Broomfield, CO (US); Carla McNearny, Arvada, CO (US); Roger Toennis, Arvada, CO (US)

(73) Assignee: AVAYA INC., Basking Ridge, NJ (US)

(21) Appl. No.: 13/345,582

(22) Filed: Jan. 6, 2012

Related U.S. Application Data
(62) Division of application No. 12/420,664, filed on Apr. 8, 2009.

(51) Int. Cl. G06F 15/16

(52) U.S. Cl. 709/204

(57) ABSTRACT

A service provider includes a broker. The broker receives a request from a business organization requestor for one or more potential collaborators in a determined subject matter area; accesses one or more personal profiles maintained by one or more social network services; selects a subset of individuals described in the accessed profiles as being of potential interest to the requestor; and provides to the requestor information describing the members of the subset of individuals.

### FIELD

The invention relates generally to social networking and particularly to professional social networks.

### BACKGROUND

In 2008, the average length of time that any given business professional in the “Global Corporate Workforce” spends working for a single employer is dramatically shorter than it was even 10 years ago. The result is rapidly changing corporate rosters that make it very difficult for cross-functional teams within a corporation to sustain productivity and momentum toward achieving business goals. The core problem is a communication problem where people inside a company often cannot easily find and contact the person who has responsibility for completing a task critical to the success of the team. This problem extends and is even more difficult to solve when the cross functional teams become “cross-corporation teams” composed of employees from multiple companies.

As an example, cross-corporate teams are particularly the norm in the “enterprise communication products” industry. Corporate buyers of networking technology products must assemble complex corporate networks that require the seamless and reliable interoperation of equipment from multiple vendors. As a result those vendors must communicate extensively, and in concert, to ensure the integrity and reliability of customer corporate networks as the suite of products in the solution evolve, and new products are released and added to the suite. The creation, organization and communications within a cross-corporate team are today fully manual processes. A new cross corporate team must be formed each time two or more companies are supporting common corporate customers who have equipment from those vendors. In each case, each team member must manually compile a set of contact information for each person on the teams of which they are a part. They must then maintain and update that information manually to be able to act productively and quickly in performing their duties.

Social networking has become a popular and convenient technique for maintaining up-to-date personal information electronically accessible to selected persons. Though the social networking trend has only recently become widely popular with the mainstream, it got its start over 15 years ago in the “pre-WWW” days of the internet. Some of the first “online” services were bulletin boards (BBSs) and chat relay (ICQ). People interacted and communicated within personally and professionally focused interest “groups” using the “usenet/UUCP” discussion groups. These Usenet groups were accessed largely using Unix-based email readers and allowed people to converse in a “public” forum about topics of mutual interest. These usenet-style groups continue to exist and maintain significant use. However, in the past 5 years a follow-on generation of web-based solutions has gained much larger interest and a much larger user community. The largest of the social networks includes solutions such as MySpace™ (Teens), Facebook™ (College/Young Adult) and LinkedIn™/Plaxo™ (Adult Professionals). In each age category there are numerous other brand names that have a significant subscription base.

A growing majority of adult professional workers are using these online networks to maintain business network relationships, search for jobs, advertise professional business services, and hire employees. This is becoming the new norm. It is replacing the practice of people relying on their network within a single company that would become rich and powerful due to long-tenured employment with a single company. In the new model, professionals are now relying primarily on their networks developed in LinkedIn™, Plaxo™, Facebook™, or a mixed combination of these networks. As professionals transition their employment from one company to the next, these networks are becoming by far people's primary means of communication with the goal of finding employment and producing business results.

Increasing churn/turnover in corporate staff, combined with the requirement for corporations to extensively partner to deliver reliably interoperable products and services, is resulting in growing customer dissatisfaction with the interoperability, reliability and capability of multi-vendor corporate solutions offered across many industries. At the heart of this problem is a communication problem in which the principle actors at each of the partner companies changes regularly. The resulting slowdown in communication and productive action is caused by a lack of infrastructure with which the cross-corporation team members can reliably and effectively communicate with the right person at the right time in the process of supporting customers.

### SUMMARY

These and other needs are addressed by the various embodiments and configurations of the present invention. The invention is directed to the interfacing of business organization databases with databases of social network services.

In one embodiment, a method includes the steps:
(a) receiving, by a service provider, a request from an organization requestor for one or more potential collaborators in a determined subject matter area;
(b) accessing, by the service provider, one or more profiles maintained by one or more social network services;
(c) selecting, by the service provider, a subset of individuals described in the accessed profiles as being of potential interest to the requestor; and
(d) providing, by the service provider, to the requestor information describing the members of the subset of individuals.

In one embodiment, a method includes the steps:
(a) accessing, by a service provider, selected employee and/or contractor information maintained by at least one of an organization and a social network service; and
(b) providing the accessed information to the other of at least one of an organization and a social network service, whereby selected fields in the records of the organization and social network service are substantially consistent and synchronized.

In one configuration, traditional corporate information and communication infrastructures, of multiple business organizations, are linked with the emerging “professional social networks” that reside and are growing in the online world. As virtually all professional employees become active users of social networks, productively bridging the 20^{th} century corporate structure with 21^{st} century adaptive networking can provide a highly effective solution to a broad class of existing and emerging problems.

The infrastructure would, with employee consent, allow for the proactive/automatic upload of a defined subset of the corporate employee database information (e.g., title, telephone number, email contact and instant messaging contact information) into the public/professional social network profiles of their employees. The system would define a comprehensive and extensible eXtensible Markup Language (“XML”) data structure and set of eXtended Style Language Template (“XSLT”) schemas that can allow for the easy portability of the professional profiles of employees, contractors, etc., between corporate databases and a variety of social networking platforms.

When corporate information is populated into the professional social networks, the system allows for an active integration of the employee profiles on that network into the corporate communication infrastructure (Private Branch eXchange (“PBX”), email, Instant Messaging (“IM”), SAP™, etc.). The business organization can elect to leverage the social network itself fully in lieu of its own corporate information databases and in lieu of its own communication infrastructure.

This approach can benefit from the fact that most employees in first world industries and professions maintain richer and more accurate profiles of themselves in their professional social networks than they do for purely corporate databases. Social networks generally have much richer, more capable, and often more reliable, business application services than those that business organizations will buy as standalone, enterprise software solutions. For example, the LinkedIn™ Hiring and Jobs board is as capable as even the best corporate HR/Jobs software platforms.

Social network services, such as the “LinkedIn™ Answers Service”, is an extremely powerful leveraging of the captured social graphs of business professionals as they pursue business information and advice. Business advice that can be found daily on LinkedIn™ would in most cases result in a significant fee if that advice was obtained using paid business consulting services.

The service can provide private group services while also allowing access to the broader social network community surrounding that cross company team.

The traceability and audit trail that would be possible with this kind of system can also clarify and streamline any inter-company problems/disputes that might otherwise lead to legal action detrimental to all parties. As people change roles or leave companies, the network solution can also enable the rapid transition in replacing a person on a team by simply traversing the social graph of people on the team to find someone nearby, in social graph state-space, with similar talent, experience, credibility and, in some cases, even “pre-existing rapport” with the rest of the team. The new person replacing the exiting team-member can be given immediate and full access to all the team context and content created to that point. This can minimize the negative impact of these transitions.

As the individual employee performs work over the years for multiple companies, he or she builds up a continuously updated record of accomplishment, recommendations and knowledge that is all readily re-usable and publishable by him or her, within the bounds of contractual agreements with prior employers, in securing their next employment or project. Ramp down off one project would be rapid as would ramp up in the next project.

Over time, this solution ecosystem can evolve to be one giant professional talent pool. In this pool, the lines between business organizations that in the past were largely defined by longterm employment of people at a single company, will be in constant motion. More and more, people will be defined by their specific expertise, and their verifiable record of accomplishments in their field of endeavor, versus their corporate title and achievements in service to a single, fixed and static company.

Societal and cultural shifts point at the value of this system. These shifts include; the adoption and use of online social networks; the business realities of rapid and regular changes in staff; the downsizing and outsourcing/offshoring of jobs to countries with low cost workforces; and the increasing corporate preference for contract workers.

The system can permit an agile and adaptable business/employee relationship management including hiring, employment, collaboration, partnering and communication within and between corporate entities while getting maximum productivity and leverage from employees across a mix of employers. Prior solutions are all static and “business organization-centric” in nature. This solution is primarily worker/employee-centric in line with the migration of all employees, whether fulltime workers with a single company or multicompany contractors, toward a more “Free Agent” mindset.

As professionals transition their employment from one company to the next, social network services are becoming by far people's primary means of communication with the goal of finding employment and producing business results. This trend has matured even to the point where people who are long-tenured at a single company, and expect to remain at that company for some time, are uploading their “in-company” networks into these external social networking tools. Given this emerging trend, it is feasible for business organizations to recognize that these networks can be used very powerfully to address the problems faced in cooperating with partner companies to deliver integrated, multi-vendor solutions; especially in those cases involving large enterprise customers.

The business organizations that might fight this emerging trend, by remaining closed to the migration of their corporate people networks into the online “professional social graph”, are likely to be the first evolutionary casualties in this punctuated societal change. The business organizations that embrace and accelerate this change are the ones who will create completely new levels of discretionary capacity from their existing staff and attract the best global talent as they partner with incoming talent.

These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “business organization” refers to any legally recognizable organizational structure, including, without limitation, partnership, joint venture, corporation, trust, and the like.

The term “collaboration” refers to an arrangement pursuant to which two or more entities work together or cooperate on a project, design, or other effort. An employee or contractor is considered to be a collaborator with his or her employer.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The terms “online community”, “e-community”, or “virtual community” mean a group of people that primarily interact via a computer network, rather than face to face, for social, professional, educational or other purposes. The interaction can use a variety of media formats, including wikis, blogs, chat rooms, Internet forums, instant messaging, email, and other forms of electronic media. Many media formats are used in social software separately or in combination, including text-based chatrooms and forums that use voice, video text or avatars.

The term “social network service” is a service provider that builds online communities of people, who share interests and/or activities, or who are interested in exploring the interests and activities of others. Most social network services are web-based and provide a variety of ways for users to interact, such as e-mail and instant messaging services.

The term “social network” refers to a web-based social network.

The term “synchronized” means, in the context of databases, maintaining selected fields in the records of one database temporally up to date with respect to changes in the information stored, by the other database, in the selected or equivalent fields.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram of a distributed processing network according to an embodiment;

FIG. 2 is a flow chart according to an embodiment;

FIG. 3 is a flow chart according to an embodiment;

FIG. 4 is a flow chart according to an embodiment; and

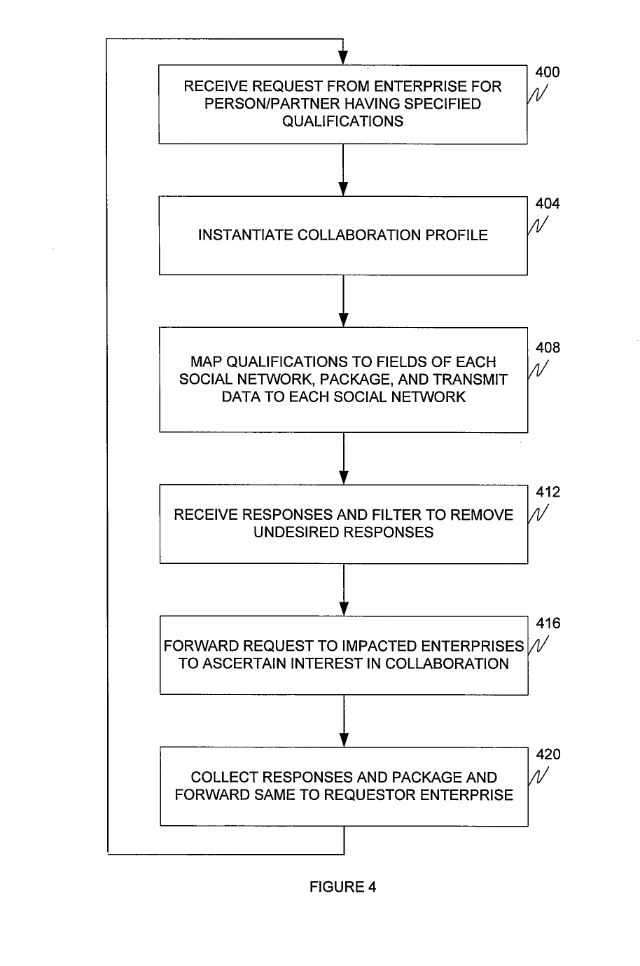

FIG. 5 is a flow chart according to an embodiment.

### DETAILED DESCRIPTION

Embodiments described herein join the traditional corporate information and communication infrastructures of multiple enterprises with professional social networks. In one configuration, the system is internet-hosted so that enterprises, such as corporations and other business organizations, can utilize the personal information in professional social networks. The system can, with employee consent, allow for the proactive/automatic upload of a defined subset of the enterprise employee database information (e.g., title, telephone number, email contact and instant messaging contact information) into the public/professional social network profiles of their employees. The system can provide a mechanism for subject matter experts, whether individuals or business organizations, to be paired with business organizations seeking collaboration partners.

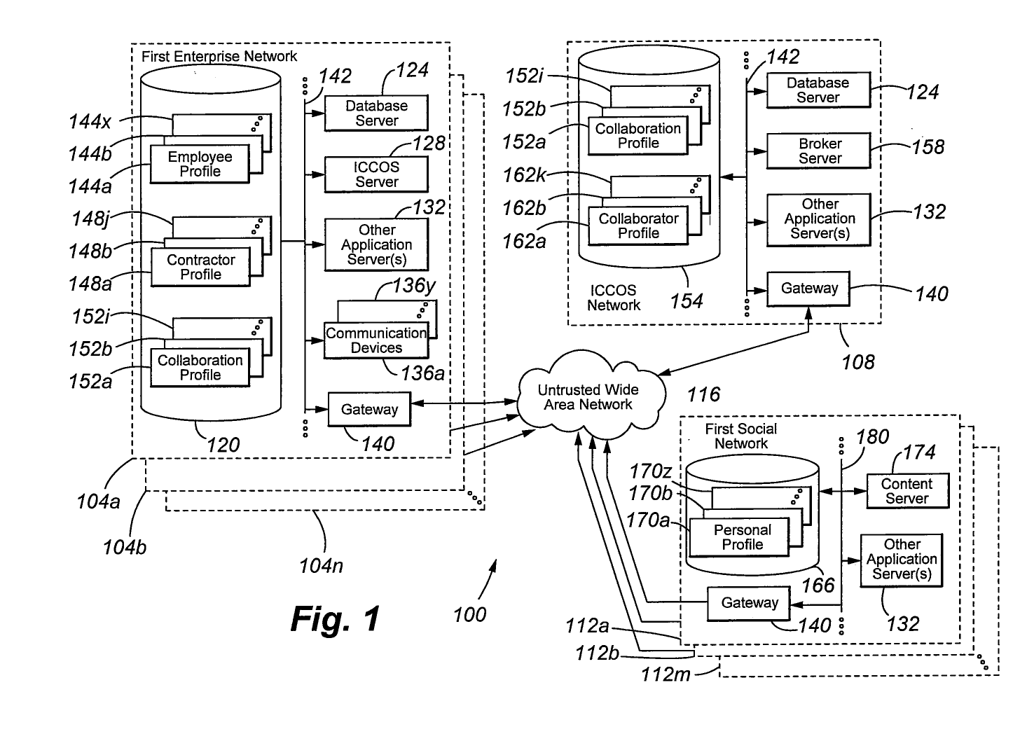

With reference to FIG. 1, a distributed processing network 100 according to a first embodiment is depicted. The network 100 includes first, second, . . . nth enterprise networks 104a-n, an Inter-Corporate Collaboration Overlay Solution (“ICCOS) network 108, and first, second, . . . mth social networks 112a-m. These components are in communication by means of an untrusted (packet-switched) wide area network 116, such the Internet.

The dotted lines surrounding each of the local area networks and its nodes indicate the DeMilitarized Zone (“DMZ”), or demarcation zone or perimeter network. As will be appreciated, the DMZ is a physical or logical subnetwork that contains or exposes an organization's external services to a larger, untrusted network, such as the Internet. It provides an added layer of security to the organization's local area network, whereby an external attacker only has access to equipment in the DMZ rather than the entire local area network. Any service provided to external users in an external network are placed in the DMZ, particularly web servers, mail servers, FTP servers, VoIP servers, and DNS servers.

The ICCOS network 108 acts as an intermediary or broker providing a hosted service of data and communication services that broker the integration of existing enterprise network infrastructures (e.g., databases, Private Branch eXchanges (“PBX's”), Instant Messaging (“IM”) servers, certificate servers, etc.). Business entities, such as corporations, would register to this inter-company brokering service for all participating employees. Once a critical mass of businesses in any industry were using this approach it would be easy to rapidly instantiate a “cross-company team” that would allow members to rapidly identify, research and communicate with cross-company team members in the productive completion of cross-company efforts.

Returning to FIG. 1, each of the first, second, . . . nth enterprise networks 104a-n includes a database 120, a database server 124 in communication with the database 120 to access and update information stored in the database 120, an ICCSOS server 128 to initiate and respond to communications with the ICCOS network 108, including pre-processing (e.g., filtering) information from the database 120 before it is delivered to the ICCOS network 108, other application server(s) 132 (e.g., an email server, a voice mail server, an instant messaging server, web server, FTP server, VoIP server, and DNS server), a plurality of communication devices 136a-y and a gateway 140, all interconnected by a trusted local area network 142.

The database 120 has a structure for accepting, storing and providing, on demand, data for one or more users or applications. The database structure can be defined by any suitable database model or schema, such as the relational model, object oriented model, hierarchical model, and network model or be schema-less. The database 120 includes various types of corporate information, such as employee profiles 144a-x, contractor profiles 148a-j, and corporate collaboration profiles 152a-i. The employee and contractor profiles include various types of personal and professional information (e.g., name, contact information, compensation information, employment description(s), dates of employment, performance reviews by non-employer collaboration organizations, evaluations, and ratings by non-employer collaboration organizations, employment experience, and professional affiliations). Collaboration profiles 152a-i contain information descriptive of an instance of an inter-corporate collaboration. Such descriptive information includes, for example, identities of collaborators (whether individuals or corporations), responsibilities of each collaborator, description of the corresponding collaboration (e.g., name and/or subject matter of collaboration, activities to be performed during collaboration and identities of actors for each activity, each collaborator's corresponding scope of work in collaboration, result of collaboration, performance evaluation or rating of each collaborator or member thereof, identities of members (e.g., employees/contractors) from each collaborator, designated contacts and contact information for each collaborator, and contact information for participants).

The database server 124 can be any suitable database management system, such as for a relational database model, or any other application programming interface that is suitable for supporting the database model used by the database 120. Exemplary database servers include those manufactured by Post™, and SAP™.

The ICCOS server 128 is an application server that interacts with the components of the ICCOS network 108 (discussed below) to provide information from the database 120 to the ICCOS network 108, update information in the database 120 to reflect information received from the ICCOS network 108, apply filtration rules to prevent unauthorized information from being forwarded to the ICCOS network 108, and otherwise handle communications between the respective enterprise network 104 and the ICCOS network 108.

The communication devices 136a-y are packet-switched computational components, such as personal computers, laptops, personal digital assistants, wired or wireless phones, and other devices for presenting information to and receiving input from a subscriber to the respective enterprise network 104.

The gateway 140 allows or controls access to a network. The gateway, also called a protocol converter, is equipped for interfacing with another network that uses different protocols. The gateway can contain devices such as protocol translators, impedance matching devices, rate converters, fault isolators, and signal translators, as necessary, to provide system interoperability. The gateway can further include security applications, such as a firewall configured to permit, deny, encrypt, decrypt, or proxy all computer traffic between different security domains based upon a set of rules and other criteria.

The ICCOS network 108 includes a number of components. Specifically, the network 108 includes a database 154, database server 124, broker 158, other application server(s) 132, and a gateway 140, all interconnected by a trusted local area network 142.

As in the case of database 120, the database 154 can be defined by any suitable database model or schema, such as the relational model, object oriented model, hierarchical model, and network model or be schema-less. The database 120 includes not only collaboration profile(s) 152a-i, which may or may not contain the same information as the collaboration profiles 152a-i in the database(s) 120, but also (and optionally) collaborator profiles 162a-k. The collaborator profiles 162a-k may contain information about actual or prospective business entity (e.g., corporate) collaborator, an individual collaborator, and the like. The information can include, in addition to the information discussed above with reference to employee and contractor profiles 144a-x and 148a-j, rules governing one or more of the preferences and restrictions on who the respective collaborator will collaborate with, the subject matter areas on which the respective collaborator will or will not collaborate, the compensation expected to participate in any collaboration, the temporal availability or unavailability of the respective collaborator to participate in a collaboration, work experience and qualifications of the respective collaborator, and a skill or historic performance rating level of the respective collaborator as determined by prior collaborative efforts.

The broker 158 periodically receives data updates from a corresponding ICCOS server 128 in one of the first, second, . . . nth enterprise networks 104a-n to forward to the first, second, . . . mth social networks 112a-m or from the first, second, . . . mth social networks 112a-m to forward to a corresponding ICCOS server 128 in the first, second, . . . nth enterprise networks 104a-n, receives and processes queries from an ICCOS server 128 regarding potential collaborators for a defined collaboration project, and receives queries indirectly from a potential collaborator, such as through a social network, or directly from the potential collaborator, seeking a potential collaborator having specified qualifications for collaboration projects. The broker 158 may assist corporations and prospective contractors in negotiating suitable contractual arrangements to govern the collaboration. The arrangements include legal, financial and logistical steps required to transact the collaboration. This may be done, for instance, by using pre-configured settings established by each business entity to execute automatically all the formerly manual steps of creating a limited duration collaborative contract for services (e.g., an employment agreement, consulting agreement, joint venture, partnership and the like). The pre-configured settings may be provided to the broker as part of the initial solicitation and include variables such as price, payment schedule, scope of work, milestones, timeframes, and other collaboration terms and conditions.

The first, second, mth social networks are operated by different social network services. Examples of social network services include MySpace™, Facebook™, Zoominfo™, Spoke™, LinkedIn™, Nexopia™, Bebo™, Hi5™, Tagged™, Xing™, Skyrock™, Orkut™, Friendster™, Xiaonei™, CareerBuilder™, Monster™, Ryze™, and Cyworld™. In a typical professional social network, for example, a contact network is built up consisting of a person's direct connections, the connections of each of their connections (termed second degree connections) and also the connections of second degree connections (termed third degree connections). This can be used to gain an introduction to someone the person wishes to know through a mutual, trusted contact. The contact network can be used to find jobs, people and business opportunities recommended by someone in the person's contact network, obtain an answer to a question from someone in the person's contact network, and/or establish new business relationships by joining, for example, alumni, industry, or professional or other relevant groups. Employers can list jobs and search for potential candidates. Job seekers can review the profile of hiring managers and discover which of their existing contacts can introduce them.

The first, second, . . . mth social networks 112a-m each include a database 166, including a number of personal profiles 170a-z, a content server 174, other application server(s) 132, and a gateway 140, all interconnected by a trusted local area network 180. The personal profiles 170a-z contain personal information selected by a respective social network member and rules governing to whom the personal information may be provided. The personal information, for example, can include name, contact information, age, educational background, employment background, interests, non-interests, current employment information, and the like. The content server 174 comprises social software, which includes one or more applications allowing subscribers to the social network to interact and share data and an explicit and/or implicit search engine. These applications can share characteristics, such as open application programming interfaces, service-oriented designs, and the ability to upload data and media. An example of such applications include collaborative software.

To enable information transfer among the various entities, a dynamically extensible data model for individual professionals and a dynamic operations language on that data model are defined that enables professionals to elaborate and extend their professional online profiles with continuously updated information emanating from their ongoing interactions in the context of all of their professional activities. The professional activities include those external to the user's main employment and those that are circumscribed within the context of the user's current employment assignment(s). In one configuration, the data model and dynamic operations language uses a consistent set of semantics, syntax, and grammar to describe a selected property or attribute. In another configuration, the data model of each network 104, 108, and 112 is extensible and readily discoverable by others.

In one configuration, the system defines a comprehensive and extensible eXtended Markup Language (“XML”) data structure and set of eXtensible Style Language Template (“XSLT”) schemas allowing for the easy portability of professional profiles of employees, contractors, etc. between enterprise databases and a variety of social networking platforms. As will be appreciated, XLST enables transformation of a class of XML documents into other XML documents by describing how an instance of the class is transformed into an XML document that uses a formatting vocabulary, such as (X)HTML or XSL-FO. This data structure may be a standards extension to OpenSocial, which defines a common application programming interface for social applications across multiple websites.

The interactions of the various networks will be described by a series of examples. The examples illustrate that the ICCOS network 108 provides an interconnected structure/architecture that links, via a trusted and intermediary brokering service, external/professional online social services, such as LinkedIn™, with enterprise networks. The ICCOS service uses the above-described structural elements in the network 108 to securely and bidirectionally “read/write” link dynamically changeable, online professional profiles 170a-z of employees with the profiles 144a-x and 148a-j captured and managed in the context of the business organization employer's database 120. The various functions and operations coordinated by the ICCOS service are trusted and in federation with both the individual and the business organization.

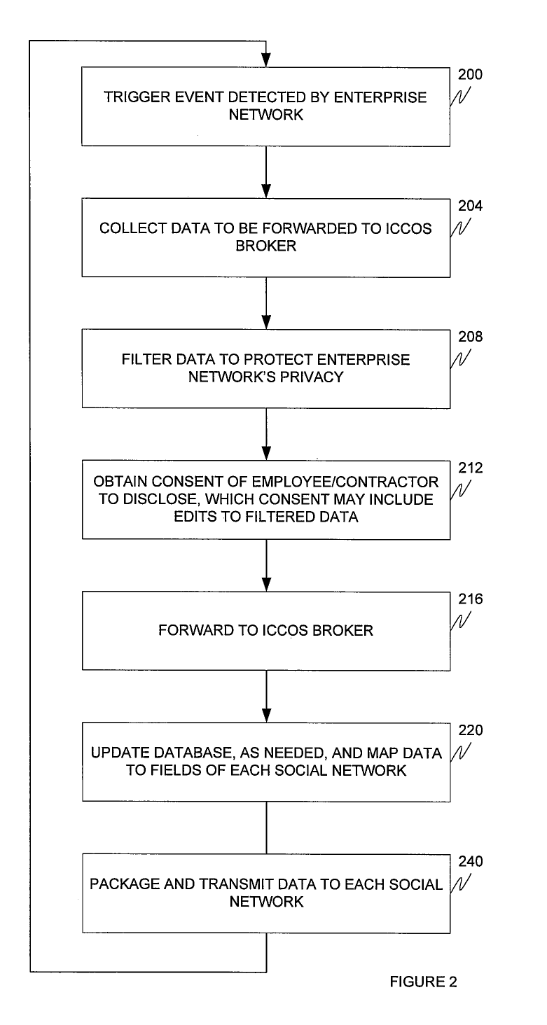

In a first example, information in the database 120 of an enterprise network is pushed to or pulled by the ICCOS network 108 for ultimate access by the first, second, . . . mth social networks 112a-m. This example will be discussed with reference to FIG. 2.

In step 200, a trigger event is detected by the ICCOS server 128. The trigger event is typically receipt of a notification from the database server 124 of an update or change to one or more fields in a specified profile 144a-x, 148a-j, or 152a-i. Alternatively, the trigger event could be receipt of a request from the broker 158 for any updates or changes to the profiles. The request is typically generated in response to a passage of time.

In step 204, the database server 124 provides specified types of data from selected files to the ICCOS server 128 for transmission to the ICCOS broker 158. The query received by the database server 124 normally has specifies the types of data and/or files from which the data is to be retrieved.

In step 208, the ICCOS server 128 applies filtration rules or policies to the data received from the database server 124 to protect specified types of information from inadvertent public disclosure. The rules may protect not only information proprietary and confidential to the organization but also to an employee or contractor. Proprietary and confidential information to the organization can be either business or technical in nature.

In step 212, further rules or policies are applied by the ICCOS server 128 to determine whether any part of the filtered data should be provided to an individual, such as an employee, contractor, or information officer, for approval or editing. If so, the subject part of the filtered data is provided to the individual on his or her subscriber communication device 136a-y before transmission to the ICCOS broker 158. When approval and/or editorial changes and comments are received, that portion of the filtered data, after modification to effect the changes and comments, is forwarded, in step 216, to the ICCOS broker 158. Any other portions of the filtered data, the disclosure of which does not require consent, may be forwarded, in step 216, separately from or collectively with the approved/edited filtered data.

Upon receipt of the filtered data from the ICCOS server 128, the broker 158, in step 220, provides the information to the database server 124. The database server 124 updates the database 154, as needed, and maps the data to fields of each social network 112a-m to receive all or part of the information. As will be appreciated, a condition of disclosure by a business organization or individual could be that specified types of information are to be provided to specified social networks. For example, a first social network 112a could receive a different subset of the information than a second social network 112b. Field mapping would not be required if all of the social networks used a common extensible data model.

In step 240, appropriate portions of the data is packaged and transmitted to each permissible social network 112a-m.

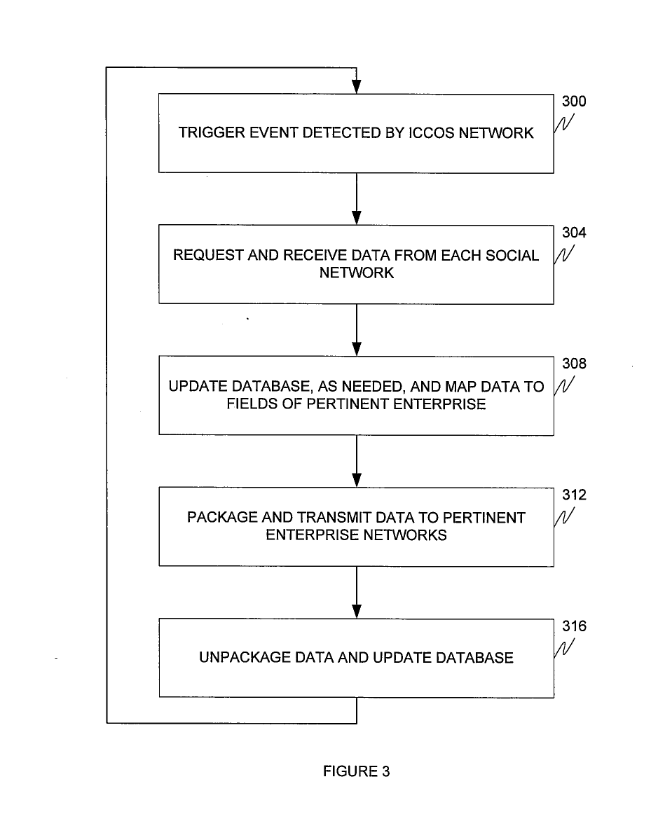

In a second example, information in the database 166 of a social network is pushed to or pulled by the ICCOS network 108 for ultimate access by the first, second, . . . mth enterprise networks 104a-n. This example will be discussed with reference to FIG. 3.

In step 300, a trigger event is detected by the ICCOS network. The trigger event may receipt of a notification from a social network of a change to a profile or be passage of a specified period of time.

In response, the broker 158, in step 304, sends a request to one or more selected social networks for specified data contained in selected personal profiles 170. The social network retrieves the data and forwards it to the ICCOS network 154. As part of the retrieval process, the social network will normally apply private rules or policies to confirm that it has authorization to provide the information to the network 154. These rules or policies may be received directly from the impacted individuals or indirectly from the ICCOS network 154 as part of the subscription process by the individual (discussed below).

In response, the broker 158, in step 308, provides the information to the database server 124. The database server 124 updates the database 154, as needed, and maps the data to fields of each enterprise network 104a-n to receive all or part of the information. As will be appreciated, a condition of disclosure by an individual could be that specified types of information are to be provided to specified enterprise networks. For example, a first enterprise network 104a could receive a different subset of the information than a second enterprise network 104b. In one configuration, additional disclosure restrictions can be imposed by a business organization with which the individual has a relationship, such as a relationship of employment. Field mapping would not be required if all of the social networks used a common extensible data model.

In step 312, the data to be disclosed to each enterprise network is packaged and transmitted to the destination.

In step 316, the data is unpackaged by the ICCOS server 128 and the database 120 updated by the database server 124.

In a third example, a request is received from a business organization for a collaboration candidate. This example illustrates how the ICCOS service acts as an intermediary in matching business organizations with one another and with individuals.

In step 400, the broker 158 receives a request from a business organization for a person or business organization partner having specified qualifications. Examples of qualifications include requisite subject matter area of expertise or business, years of experience, skill level, compensation levels, educational background, and the like. The request may include specific identities of potential business collaborators. The request may include restrictions as to eligibility. For instance, the request may specify that the partner not be company X (a competitor), that the individual not work for company X, that the individual not be a prior employee of the requestor, and that the individual not be from certain countries (such as North Korea).

In step 404, the database server 124 instantiates a collaboration profile 152 for the request.

In step 408, the broker 158 itself maps or causes the mapping of qualifications to fields of each collaborator profile 162a-k and/or to fields of each personal profile 170a-z in one or more social networks 112a-m to identify a set of potential business organization and/or individual collaborators. In one configuration, the mapping is performed by servers in the social networks.

In step 412, the broker 158 receives the various responses and applies rules and polices to remove undesired responses. Responses may be undesired due to a negative restriction received from the requestor as discussed above, a failure to meet fully the requisite qualifications, and/or a violation of a rule or policy received from the potential collaborator. The candidate collaborator itself may have configured, as part of its collaborator profile 162, rules and restrictions on whom it is willing to collaborate with or on what subject matter areas it is willing to collaborate in.

In step 416, data on the filtered candidate collaborators are either forwarded to the requestor and/or the request itself is forwarded to the candidate collaborators for consideration.

In step 420, candidate collaborator responses are collected, packaged and forwarded to the requestor. When a candidate collaborator indicates a willingness to be considered by the requestor, data on that candidate collaborator is forwarded to the requestor. When the candidate collaborator indicates a willingness to be considered by the requestor, data on that candidate collaborator is not forwarded to the requestor.

The requestor can then contact directly candidate collaborators to negotiate the terms and conditions of the collaboration.

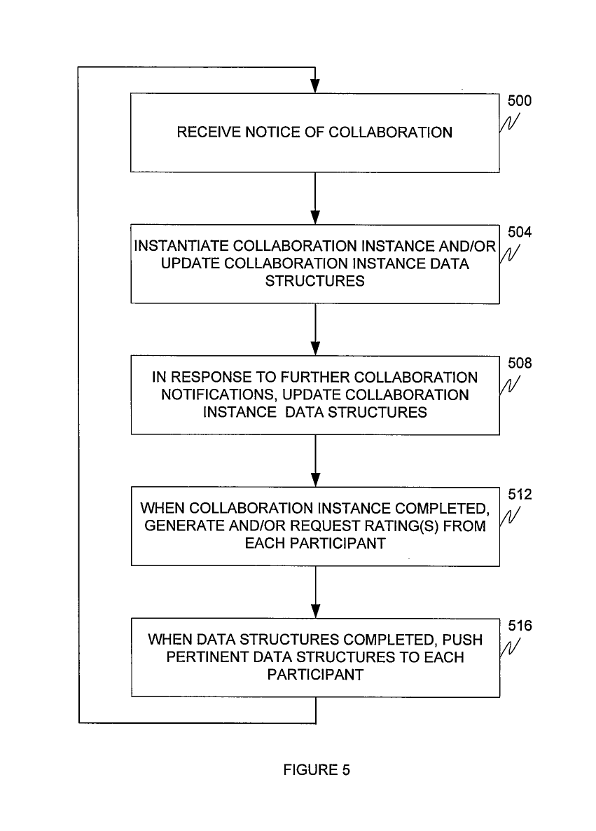

A fourth example will now be discussed with reference to FIG. 5. This example describes how collaboration instances are tracked by the ICCOS network 154.

In step 500, the ICCOS network 154 receives notice from a business organization of a collaboration. The notice includes the identities of the collaborators, the subject matter of collaboration, the period of collaboration, the terms and conditions of the collaboration, and the like.

In step 504, the database server 124 instantiates a collaboration profile 162 and/or updates an existing collaboration profile.

In step 508, the server 124, in response to subsequent collaboration notifications, updates the profile. Further collaboration notifications contain information related to the progress of the collaboration, such as changes (additions/deletions) to collaborators, objectives realized, result of collaboration, skill ratings of other collaborators, and the like. Notifications are typically received from multiple collaborators involved in the same collaborative effort. In one configuration, the collaborative profile may act as an electronic bulletin board. It may receive communications or documents from a collaborator or an employee or contractor thereof for another collaborator or employee or contractor thereof. Each collaborator or employee/contractor for whom the communication is intended would receive a notice that the communication had been posted to the board. After authentication, the notified collaborator or employee/contractor could retrieve the communication or other electronic document.

In step 512, when the collaboration instance is completed the broker 158 generates and/or requests skill ratings from each participant about the other participants. The skill ratings may be configured as a level of satisfaction of the performance of the other participants. The various ratings for a participant received in various collaborations may be recorded and/or combined in some fashion to provide a consolidated rating. In the combination algorithm, the current rating may be weighted more or less heavily than the prior consolidated rating. In one configuration, the rating algorithm is as follows:

CR_{NEW}=(X)(CR_{OLD})*(1−X)(R_{NEW})

where X is the weighting factor, CR_{OLD} is the prior cumulative rating for a selected collaborator, R_{NEW} is the rating received for the selected collaborator as part of a current notification, and CR_{NEW} is the new cumulative rating for the selected collaborator.

In optional step 516, when the collaboration is completed, selected fields of the collaboration profile is pushed to the selected participants. In one configuration, different sets of fields are provided to different collaborators on the same collaborative effort. In one configuration, whenever a change to a selected set of fields occurs to the profile 162a-k of a collaborator, an update to the profile is pushed not only to the collaborator corresponding to the profile but also to business organizations that have subscribed with the ICCOS network 108 to be notified of such changes. What fields are published to subscribers can be restricted by the collaborator corresponding to the profile 162.

The various communication channels are preferably secure. Multi-business organization or collaborative projects are quite common in some industries, and often these projects have significant security requirements. Some security requirements are simply due to the fact that multiple independent business organizations are working together on a given project, but need to maintain security of their non-project resources. For example, companies participating in joint development of gateway or gate keeper control algorithms are protective of their proprietary and intellectual property assets that are not related to the joint project. Hence, companies do not want other companies to have access to their assets and, consequently, they need to ensure that their intranets are secure from unauthorized sources outside of the company. Thus, there are many contexts in which a working environment should afford the ability to openly communicate and collaborate among authorized participants in a project, while at the same time be secure enough to protect some assets from undesired access.

Security is provided not only by rules and policies implemented by the ICCOS server 128 and broker 158 but also by using authentication and establishing secure channels of communication over the untrusted network 116. Authentication may be performed in any suitable fashion. For example, authentication may be effected using digital certificates (with the certificate authority being the ICCOS network 154), and entry of an identity and/or protected password. The secure channel may be established using a suitable encryption/decryption algorithm that employs either symmetric or asymmetric keys. An example is a public and private key pair. The symmetric or asymmetric key pair could be generated and issued by the ICCOS network and provided in or out of band to each collaborator.

The business model to encourage business organizations and individuals to use the architecture 100 could be configured in many ways. For instance, business organizations would subscribe for a fee to the ICCOS service in exchange for access to current information on other enterprises, employees and contractors thereof, and individuals, which may already have an existing relationship with the business organization subscriber. The ICCOS service is thus operated by a business organization different from the business organizations seeking collaborative assistance. Alternatively, the business organizations could pay a transaction fee to the ICCOS service on a collaboration-by-collaboration basis. In exchange for consenting to permit disclosure of their personal profiles on one or more social network services to the ICCOS service for possible disclosure to a business organization subscriber, which may be a potential or current employer, the use of the ICCOS service would be free for individuals. As part of the graphical user interface offered to organization and/or individual subscribers, advertisements could be provided in exchange for fees paid by advertisers.

The exemplary systems and methods of this invention have been described in relation to specific network configurations. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as an application server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1-6. (canceled)

7. A method, comprising:
(a) accessing, by a service provider, selected employee and/or contractor information maintained by at least one of an organization and a social network service; and
(b) providing the accessed information to the other of at least one of an organization and a social network service, whereby selected fields in the records of the organization and social network service contain substantially consistent information and are substantially synchronized.

8. The method of claim 7, wherein the service provider, organization, and social network service are different business organizations and wherein step (a) comprises the sub-step:
(A1) filtering, by the at least one of a business organization and social network service, employee and/or contractor information to provide the selected employee and/or contractor information for access by the service provider.

9. The method of claim 7, wherein the service provider, business organization, and social network service are different business organizations and wherein step (a) comprises the sub-step:
(A1) providing the selected employee and/or contractor information describing an individual to the individual for review and approval before providing the selected employee and/or contractor information for access by the service provider.

10. The method of claim 7, wherein the at least one of a business organization and social network service is the business organization.

11. The method of claim 7, wherein the at least one of a business organization and social network service is the social network service.

12. The method of claim 7, wherein the at least one of a business organization and social network service comprises multiple entities and wherein differing sets of selected employee and/or contractor information is provided to different ones of the entities.

13. A computer readable medium comprising processor executable instructions that, when executed, perform the steps of claim 7.

14-20. (canceled)
